(19) United States
(12) Patent Application Publication
(10) Pub. No.: US 2025/0077528 A1
(43) Pub. Date: Mar. 6, 2025

(54) FAST RECORD MATCHING USING MACHINE LEARNING

(71) Applicant: INTUIT INC., Mountain View, CA (US)

(72) Inventors: Nazanin Zaker HABIBABADI, Sunnyvale, CA (US); Xue HAN, Sunnyvale, CA (US); Wei WANG, Cupertino, CA (US)

(21) Appl. No.: 18/240,819

(22) Filed: Aug. 31, 2023

(51) Int. Cl. G06F 16/2457; G06N 3/0455

(52) U.S. Cl. CPC G06F 16/24578; G06N 3/0455

(57) ABSTRACT

The present disclosure provides techniques for fast record matching using machine learning. One example method includes receiving a request indicating one or more attributes, identifying, from a plurality of records using a first machine learning model, a set of records, wherein each record of the set of records indicates the one or more attributes, computing, for each record of the set of records using a second machine learning model, a first relevance score for the record, computing, for each record of the set of records using a third machine learning model, a second relevance score for the record, and identifying, based on the first relevance score for each record of the set of records and the second relevance score for each record of the set of records, a given record of the set of records best matching the request.

### INTRODUCTION

Aspects of the present disclosure relate to fast record matching using machine learning.

Different pieces of information about an entity are often scattered in different databases, such as in distributed databases or across databases maintained by different organizations. An organization often request information from another organization for use in its decision making process. For example, a financial service organization (e.g., a bank) may request financial information (e.g., financial health) about an entity (e.g., a small business) from a credit reporting agency to decide whether to grant the entity a loan. Such information sharing operations require matching records from the different databases.

However, different databases often store information in different formats or with different specifications. In addition, inconsistent pieces of information for an entity are often registered across different databases. As such, these challenges cause existing techniques to match slowly or inaccurately, and sometimes fail to find a matching record for an entity altogether. This can result in errors and inefficiencies in record matching, increased overhead to accommodate such errors and inefficiencies, and waste of precious computational resources and manpower to resolve such errors and inefficiencies.

Accordingly, improved systems and methods are needed for record matching to facilitate information sharing across different databases.

### BRIEF SUMMARY

Certain embodiments provide a method for fast record matching using machine learning. The method generally receiving a request indicating one or more attributes, identifying, from a plurality of records using a first machine learning model, a set of records, wherein each record of the set of records indicates the one or more attributes, computing, for each record of the set of records using a second machine learning model, a first relevance score for the record, computing, for each record of the set of records using a third machine learning model, a second relevance score for the record, and identifying, based on the first relevance score for each record of the set of records and the second relevance score for each record of the set of records, a given record of the set of records best matches the request.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of the various embodiments.

### BRIEF DESCRIPTION OF DRAWINGS

The appended figures depict certain features of the various aspects described herein and are not to be considered limiting of the scope of this disclosure.

FIG. 1 depicts an example record matcher for fast record matching using machine learning.

FIG. 2 depicts an example workflow for fast record matching using machine learning.

FIG. 3 is a flow diagram of example operations for fast record matching using machine learning.

FIG. 4 depicts an example application server related to embodiments of the present disclosure.

### DETAILED DESCRIPTION

Aspects of the present disclosure provide apparatuses, methods, processing systems, and computer-readable mediums for fast record matching using machine learning.

Existing approaches for matching records often rely on a common identifier, utilize partial information, or perform fuzzy matching in the presence of incomplete or incongruent information. However, these approaches do not take into consideration the rapid addition and deletion of records in databases and the presence of inaccurate and incomplete records stored in the databases, resulting in errors and inefficiencies in record matching, increased overhead to accommodate such errors and inefficiencies, and waste of precious computational resources and manpower to resolve such errors and inefficiencies.

While conventional record matching techniques is sub-optimal in record matching, embodiments of the present disclosure utilize particular machine learning techniques to accurately identify and retrieve a matching record in a local database for a record from an outside database for further analysis.

According to embodiments of the present disclosure, a request from a user (e.g., an organization or an individual) can correspond to an outside record in the outside database for matching, and the request may specify several attributes to identify an entity. The request may then be used to find a matching record in a local database.

To find a matching record for the request in a local database, records in the local database are first pre-cleaned to remove invalid records. The pre-cleaning can be performed using a machine learning model, such as a Bidirectional Encoder Representations from Transformers (BERT) name entity recognition (NER) model. BERT NER models are used to identify data items such as addresses, contact names, and the like in cases where such data items are surrounded by invalid characters, are entered into incorrect fields (e.g., incorrect table columns), and/or the like. For example, a BERT NER model may be used to identify an address that was incorrectly entered in an email column. Invalid records (e.g., records with incomplete or inaccurate values) in the local database can be removed iteratively. For each attribute of the attributes of the request, records that have invalid attribute values (e.g., null values, erroneous values, and so on) are removed from further consideration. Pre-cleaned records represent the valid records that can be possibly matched with an outside record.

Machine learning models can be employed to compute relevance scores measuring how closely related each pre-cleaned record is to the request to match with an outside record. Computing relevance scores by multiple machine learning models can enhance the robustness of the matching process and increase the accuracy of the matching result.

One of the models can compute, for each pre-cleaned record, a first relevance score to the request. The attribute values of the attributes of each pre-cleaned record can be combined and encoded into an encoded vector using a machine learning model, such as a BERT encoder. A set of weights can be computed for each pre-cleaned record using a ranking algorithm with historical or simulated requests. The encoded vector and the set of weights can be combined to generate a weighted vector for each pre-cleaned record. The weighted vector can, through the set of weights, emphasize useful features or discount less useful features as compared to its corresponding encoded vector.

The model can also encode the combined attribute values indicated in the attributes of the request to generate an encoded request, which can be used as a query to search the weighted vectors. The search algorithm can utilize tools for faster performance, such as a fast search library. Depending on the ranking of the weighted vectors in a search, the corresponding pre-cleaned records are assigned scores as the first relevance score.

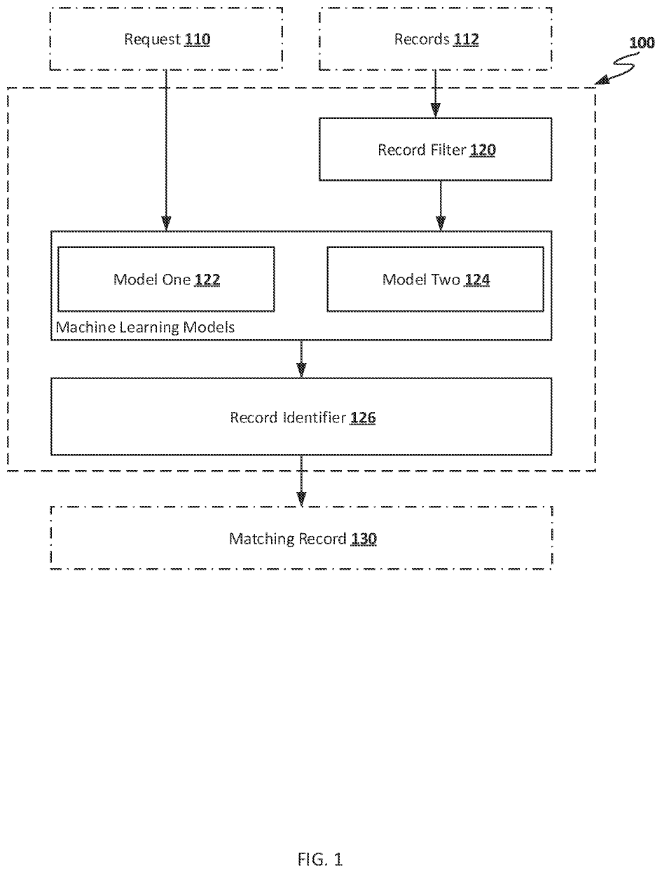

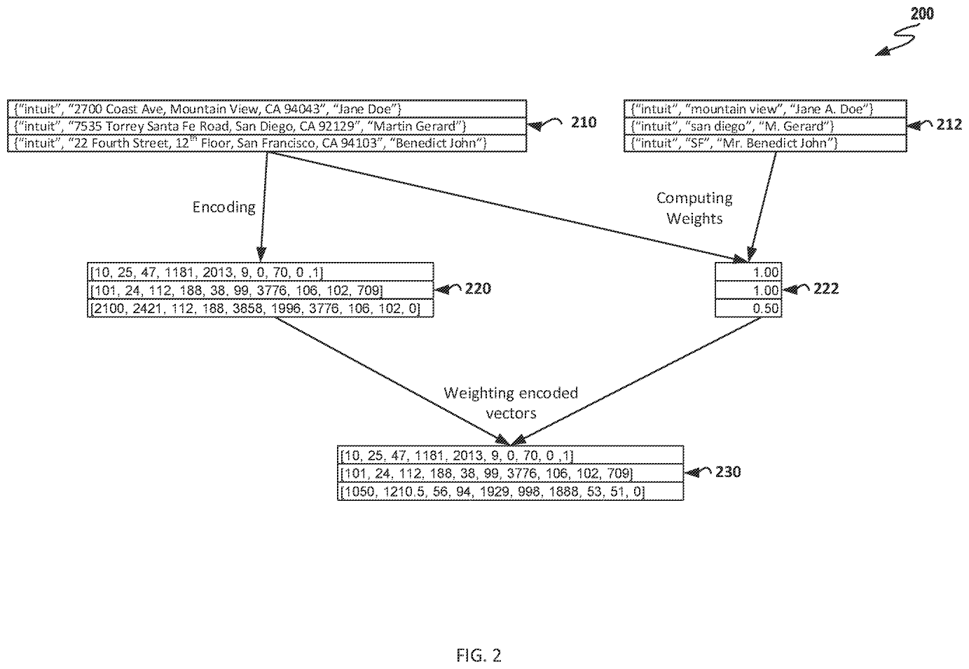

For the model discussed above, the encoder can be trained (e.g., pre-trained or retrained) while the ranking algorithm can be fine-tuned to better represent the records in the local database. Details regarding training the encoder or fine-tuning the ranking algorithm can be found below with respect to FIGS. 1-2.

Another model can compute, for each pre-cleaned record, a second relevance score to the request. This model can first cluster the pre-cleaned records according to one attribute (e.g., entity name) and then determine a cluster that the request most correlates with. For each record in the cluster of records, the model can compute a similarity score between the attribute value of the record and the attribute value of the request, for each attribute, except the attribute used to cluster the records. The similarity scores can be combined as the second relevance score for the request. Conversely, records not in the cluster can be considered as not so relevant to the request and assigned 0 for its second relevance score (e.g., by assigning 0 to its similarity scores).

The first relevance scores and the second relevance scores for the pre-cleaned records can be combined to rank the pre-cleaned records. The pre-cleaned record with the highest combined relevance score (e.g., and/or with a combined relevance score above a threshold) can be recognized as the matching record in the local database for the outside record. In some cases, a matching threshold is used, such that if there is no pre-cleaned record with a relevance score above the threshold, then no result is returned.

Accordingly, by pre-cleaning records in the local database, techniques described herein account for the dynamic changes in databases by eliminating erroneous and incomplete records from matching, allowing for more accurate, more convenient, and higher quality record matching. In addition, the use of multiple machine learning models enhances robustness of the matching process and increase the accuracy of the matching result. Matching the records with requests through their encodings also reduces dimensions of the search space, greatly accelerating the matching process and saving computational resources. As a result, the fast record matching using machine learning can allow for faster and more accurate matching results. Accordingly, embodiments of the present disclosure avoid inefficiencies associated with suboptimal identification and retrieval of records that include critical information, and improve the speed and accuracy of record matching through the use of particular machine learning techniques.

### Example Record Matcher for Fast Record Matching Using Machine Learning

FIG. 1 depicts an example record matcher 100 for fast record matching using machine learning.

Record matcher 100 can find, for request 110 (e.g., a query), matching record 130 from records 112. Request 110 can indicate one or more attributes of an entity from an outside record (e.g., a record from an outside database that is “outside” with respect to a source of request 110, such as being located on a separate component, device, and/or network from a component, device, and/or network that is the source of request 110). For example, the attributes (e.g., as fields) can include an entity name, an entity address, and entity contact information (e.g., email, phone number, contact name, and so on) of the entity. In the following discussion, request 110 is assumed to include attributes represented as strings. However, request 110 can include attributes represented as other suitable data structures (e.g., numerical values, dictionaries, and so on).

Records 112 can be stored in and retrieved from a database (e.g., a local database, such as a monolithic database or a distributed database). Some records in records 112 may have incorrect, invalid (e.g., due to parsing errors), or missing information so that the records could not be considered as valid matches for request 110. Therefore, pre-cleaning is performed on records 112 to find valid matches for request 110 to reduce the possible records available for matching.

Records 112 can be provided as the input to record filter 120 to identify a set of records that can be considered as valid matches. From records 112, the set of records may be identified by record filter 120 as possible valid matches for request 110, wherein each record of the set of records indicates the one or more attributes of request 110, as discussed above. Following the example above, each of the set of records identified can also indicate a name, an address, and contact information (e.g., as fields).

In some examples, the set of records are identified using a machine learning model, such as a Bidirectional Encoder Representations from Transformers (BERT) name entity recognition model. In such examples, an iterative process is employed to find the set of records from records 112 by record filter 120. Following the example above, record filter 120 can, for each attribute of the attributes (e.g., the entity name, the entity address, or the entity contact information), remove all the records that have invalid attribute values in records 112. Invalid attribute values can include null values, meaningless values (e.g., corrupted texts due to parsing errors or encoding errors), inaccurate or incorrect values (e.g., misspellings), values for another attribute (e.g., having contact information in an entity name attribute), and so on.

Machine learning models can be used to compute relevance scores measuring how closely related each record in the set of records is to request 110. Computing relevance scores by multiple machine learning models can enhance the robustness of the matching process and increase the accuracy of finding the matching record 130 for request 110. As depicted, this example includes two machine learning models, namely Model One 122 and Model Two 124, though additional machine learning models can be used in the computation.

Model One 122 can compute, for each record of the set of records, a first relevance score for the record to request 110. Model One 122 can encode each record of the set of records as an encoded vector. For example, the attribute values of the attributes of each record can be combined (e.g., concatenated or otherwise grouped or combined) as a combined attribute value. A machine learning based encoder, such as a BERT encoder, can be applied to the combined attribute value of the record to generate an encoded vector (e.g., an embedding) for the record.

In some examples, the BERT encoder is a pre-trained BERT encoder. In some examples, alternatively or additionally, the BERT encoder is retrained with training samples including combined attribute values of pre-cleaned historical records in the same database or in similar databases. Retraining a pre-trained BERT encoder on local data utilizes transfer learning to allow the retrained BERT encoder to adjust to local data (e.g., pre-cleaned local records). Details regarding retraining BERT encoder can be found below respect to FIG. 2.

Model One 122 can also compute a set of weights for each record based on the combined attribute value of the record. The set of weights may represent how frequently its attribute values appear in the record itself. In some examples, each weight of the set of weights is a singular numerical value. The set of weights for a record can be combined (e.g., through elementwise multiplication) with the encoded vector for the record to compute a weighted vector. For example, each dimension of the encoded vector may correspond to a different attribute, and may be multiplied by the weight of the set of weights that corresponds to the attribute to which the dimension corresponds.

In some examples, a set of weights for a record is computed with a corresponding past request (e.g., a historical or simulated request matching the record), where the attribute values (e.g., represented as strings) of the past request are regarded as search terms and the combined attribute value of the record is regarded as the document for the search.

In such examples, the set of weights is computed using a ranking algorithm, such as Term Frequency-Inverse Document Frequency (TF-IDF) or Best Match 25 (BM25). In some examples, the ranking algorithm can be fine-tuned (e.g., by adjusting hyperparameters through gradient descent, grid search, cross validation, and so on). Details regarding computing the set of weights and fine-tuning the ranking algorithm can be found below with respect to FIG. 2.

After generating the weighted vectors for the set of records, Model One 122 can also encode request 110 (e.g., by encoding the combined attribute value of the attributes of request 110) as a vector (e.g., an embedding). The encoded request can be used as a search query in a search algorithm, such as the Non-Metric Space Library (NMSLIB), to search the best matching weighted vectors. A set of search results can be generated, which indicates the records in the set of records and the rankings for their associated weighted vectors. A first relevance score can be assigned to each record in the set of records based on their rankings. In some examples, the top ranked record can be assigned a first relevance score of 3, the second top ranked record a first relevance score of 2, the third top ranked record a first relevance score of 1, and the rest of the records a first relevance score of 0.

Similarly, Model Two 124 can compute, for each record of the set of records, a second relevance score for the record to request 110. Model Two 124 can first cluster, using a clustering algorithm, the set of records into one or more clusters based on one given attribute of the one or more attributes. In some examples, the clustering algorithm includes k-means algorithm, k-medoid algorithm, hierarchical clustering algorithm, or density-based spatial clustering of applications with noise (DBSCAN). As a result, records in the same cluster share similar attribute values (e.g., having similar entity names) for the one given attribute (e.g., entity name).

Model Two 124 can then determine if the record is in a given cluster, wherein the given cluster includes one record whose attribute value of the one given attribute matches the attribute value of the one given attribute of request 110. If the record is within the given cluster, the record can be regarded as relevant to request 110 and further computations are performed to assign a second relevance score for the record. Conversely, if the record is not within the given cluster, the record can be regarded as relatively not relevant to request 110 and will be assigned a second relevance score of 0 instead. Clustering the records can significantly reduce computations needed for the second relevance scores.

In an example, the one given attribute is entity name, request 110 indicates “INTUIT” as the entity name, and a given cluster of records include records for “INTUIT,” “Intuit,” “intuit” and “INTU”. Accordingly, Model Two 124 can determine that a record indicating “Intuit” as the entity name is within the given cluster, whereas another record indicating “INDU” as the entity name is not within the given cluster.

Model Two 124 can further compute, for each attribute of the record not used to cluster the records (e.g., each attribute except the one given attribute), a similarity score between the attribute value of the record and the attribute value of request 110. In some examples, the similarity scores are computed based on a distance metric, such as Levenshtein distance. In some examples, the similarity score for an attribute is inversely proportional to the distance between the attribute value of the record and the attribute value of request 110.

Following the example above, the one given attribute is entity name and the attributes except the one given attribute are entity address, and entity contact information. For the record indicating “Intuit” as the entity name, Model Two 124 can compute a similarity score between the entity address of the record and the entity address of request 110 as well as a similarity score between the entity contact information of the record and the entity contact information of request 110.

In some examples, an attribute (e.g., entity address) includes sub-attributes (e.g., address line and zip code), such that Model Two 124 computes, for each sub-attribute, a sub-similarity score between the sub-attribute value of the record and the sub-attribute value of request 110 and combines (e.g., through addition, weighted addition, and/or the like) the sub-similarity scores into a similarity score.

Model Two 124 can assign a second relevance score to the record based on the similarity scores using a machine learning model. In some examples, the machine learning model includes one or more of a linear regression model, a logistic regression model, a decision tree, a random forest, a support vector machine, or a gradient-boosted tree. For example, the similarity scores can be regarded as input features to the machine learning model to compute the second relevance score for the record.

The first relevance scores and the second relevance scores can be provided as inputs to record identifier 126 to find matching record 130 who attribute values of the attributes best matches the attribute values of the attributes for request 110. For example, record identifier 126 can combine (e.g., through addition, weighted addition, or the like) the first relevance scores and the second relevance scores for the set of records to generate combine relevance scores, and then rank the combined relevance scores. The record that corresponds to the highest combined relevance score (and/or having a combined relevance score above a threshold) can be identified as matching record 130.

Matching record 130 may include information of interest (e.g., credit score for the entity) to the requester. Such information from matching record 130 can then be identified and provided to the requester and/or one or more additional operations may be performed based on matching record 130 (e.g., automatically updating a workflow of an application, populating one or more variables, making one or more automated determinations, and/or the like).

### Example Workflow for Generating Weighted Vectors Using Machine Learning

FIG. 2 depicts an example workflow 200 for generating weighted vectors using machine learning. The weighted vectors generated by workflow 200 can be the weighted vectors discussed with respect to FIG. 1. Workflow 200 can be performed by a machine learning model, such as Model One 122 as depicted in FIG. 1.

As depicted, workflow 200 receives pre-cleaned records 210 and past requests 212. For example, pre-cleaned records 210 can be the set of records while past requests 212 can be the historical or simulated requests, as discussed with respect to FIG. 1. In the following discussion, each pre-cleaned record 210 is assumed to have a corresponding past request 212, such that a past request 212 would match with a specific pre-cleaned record 210.

Workflow 200 can encode pre-cleaned records 210 to generate encoded vectors 220. For example, the encoding can be performed by the BERT encoder discussed with respect to FIG. 1. In some examples, the BERT encoder is pre-trained or retrained on pre-cleaned local records in the same database or similar databases (e.g., databases storing data with similar attributes), such as pre-cleaned records 210. Pre-training or retraining on pre-cleaned local records ensures that the BERT encoder correctly represents and emphasizes the information in pre-cleaned records rather than information in incomplete or incorrect records

For each pre-cleaned record 210, workflow 200 can compute weights 222 with respect to its corresponding past request 212. For example, weights 222 can be the set of weights discussed with respect to FIG. 1. Although shown as a single numerical value for each pre-cleaned records 210, weights 222 can be represented using other formats, such as a vector.

To compute weights 222 for the pre-cleaned record 212, the attribute values of its corresponding past request 212 are regarded as search terms, while the pre-cleaned record 212 (e.g., its combined attribute value) is regarded as the document for the search, as discussed with respect to FIG. 1. The search terms and the document are provided to a ranking algorithm to compute weights 222 for the pre-cleaned record 212, discussed with respect to FIG. 1. Weights 222 can be used to emphasize useful features or discount less useful features in the corresponding encoded vector 220.

In some examples, alternatively, weight factors are computed for each pre-cleaned record 212 using the ranking algorithm iteratively for each past request 212. The weight factors can be combined (e.g., through weighted addition).

Subsequently, workflow 200 can combine weights 222 for a pre-cleaned record 212 with (e.g., by elementwise multiplication) encoded vector 220 for the pre-cleaned record 212 to generate weighted vector 230.

Weighted vectors 230 can be searched with a search algorithm by a query, such as the encoded request discussed with respect to FIG. 1, where the search algorithm ranks the weighted vectors (e.g., according to how much they are related to the query). The search algorithm can generate a set of search results indicating pre-cleaned records 210 and the rankings for their associated weighted vectors.

To fine-tune the ranking algorithm (e.g., BM25), rankings from the search algorithm are used to adjust the hyperparameters of the ranking algorithm, such that for a specific past request 212, the weighted vector associated with the matching pre-cleaned record 210 would rank the highest while other weighted vector would rank lower.

In one particular example, the ranking algorithm may be represented by the following formula: IDF* ((k+1)*tf/((tf+k)*(1−b+b*))), where IDF refers to inverse document frequency (with documents corresponding to pre-cleaned records), k refers to a maximum frequency, tf refers to term frequency, and b is a parameter to adjust the impact of text length.

In a particular implementation, weighted vectors 230 may be determined by a process represented by the following pseudocode. Where bm25 refers to the example formula set forth above:

$$vector = ft\_model [ word ] \# get embedding weight = ( bm 25. idf [ word ] * ( ( bm 25. k 1 + 10 ) * bm 25. doc\_freqs [ i ] [ word ] ) ) / ( bm 25. k 1 * ( 1. - b 25. b + bm 25. b * ( bm 25. doc\_len [ i ] / bm 25. avgdl ) ) + bm 25. doc\_freqs [ i ] [ word ] ) weighted\_vector = vector * weight$$

As explained above, once the weighted vectors are determined, an encoded request can be used as a search query in a search algorithm, such as the Non-Metric Space Library (NMSLIB), to search the best matching weighted vectors. Search algorithms such as NMSLIB allow for highly efficient searching through the use of a search index that enables search speeds that are orders of magnitude faster than finding similar vectors using a brute force search approach. For example, the search index may be represented in pseudocode as: index=nmslib.init (method=‘hnsw’, space=‘cosinesimil’).

It is noted that techniques described herein allow pre-cleaned records 210 to be matched to past requests 212 even when there are differences in the attribute values. For example, the contact name in the first of pre-cleaned records 210 is “Jane Doe” while the contact name in the first of past requests 212 is “Jane A. Doe”. While these two strings are not identical, techniques described herein for the match to be identified.

### Example Operations for Fast Record Matching Using Machine Learning

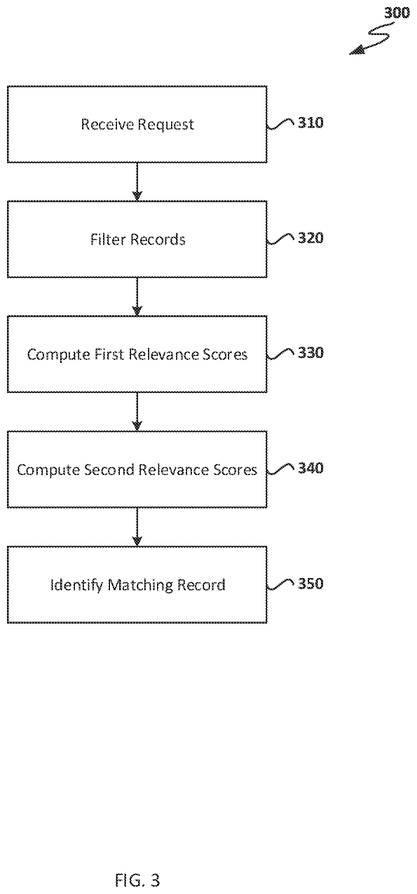

FIG. 3 is a flow diagram of example operations 300 for fast record matching using machine learning. Operations 300 may be performed by a record matcher, such as record matcher 100 as illustrated in FIG. 1.

Operations 300 begin at 310, where a request indicating one or more attributes is received. For example, the request can be request 110 as illustrated in FIG. 1.

At 320, a set of records are identified from a plurality of records using a first machine learning model, wherein each record of the set of records indicates the one or more attributes. For example, the set of records can be the set of records discussed with respect to FIG. 1 or pre-cleaned records 210 as depicted in FIG. 2.

In some embodiments, the first machine learning model comprises a Bidirectional Encoder Representations from Transformers (BERT) name entity recognition model.

At 330, a first relevance score for the record is computed for each record of the set of records using a second machine learning model. For example, the first relevance score can be the first relevance score discussed with respect to FIG. 1 while the second machine learning model can be Model One 122 as depicted in FIG. 1. In some embodiments, the second machine learning model comprises a BERT encoder.

In some embodiments, computing, for a given record of the set of records using the second machine learning model, the first relevance score for the given record comprises retrieving a weighted vector for the given record, wherein the weighted vector is generated by combining an encoded vector for the given record and a set of weights for the given record, wherein the encoded vector for the given record is generated using the second machine learning model based on one or more attribute values for the one or more attributes indicated by the given record, and wherein the set of weights for the given record are generated using a ranking algorithm with respect to a past request associated with the given record, generating, using the second machine learning model, an encoded request based on one or more attribute values for the one or more attributes indicated by the request, searching for the encoded request in a set of weighted vectors comprising the weighted vector using a search algorithm to generate a set of search results, wherein each search result in the set of search results indicates a respective record in the set of records and a ranking for the respective record, and assigning a score based on the ranking of the given record in the set of search results.

For example, the weighted vectors can be weighted vectors 230, the encoded vector can be encoded vectors 220, and the set of weights can be weights 222, and the past request can be a past request 212 as depicted in FIG. 2.

In such embodiments, the ranking algorithm comprises Term Frequency-Inverse Document Frequency (TF-IDF) or Best Match 25 (BM25). In such embodiments, additionally, the search algorithm comprises Non-Metric Space Library (NMSLIB).

At 340, a second relevance score for the record is computed for each record of the set of records using a third machine learning model. For example, the second relevance score can be the second relevance score discussed with respect to FIG. 1 while the third machine learning model can be Model Two 124 as depicted in FIG. 1. In some embodiments, the third machine learning model comprises one or more of a linear regression model, a logistic regression model, a decision tree, a random forest, a support vector machine, or a gradient-boosted tree.

In some embodiments, computing, for each record of the set of records using the third machine learning model, the second relevance score for the record comprises, clustering, using a clustering algorithm, the set of records into one or more clusters based on one given attribute of the one or more attributes of the set of records, determining that the record is in a given cluster of the one or more clusters, wherein the given cluster includes one record whose attribute value of the one given attribute matches the attribute value of the one given attribute of the request, computing, for each respective attribute of the one or more attributes of the set of records except the one given attribute, a similarity score between the attribute value of the record and the attribute value of the request, and assigning a score based on the similarity scores using the third machine learning model.

For example, the one given attribute can be entity name while the respective attributes except the one given attribute can be entity address and entity contact information, as discussed with respect to FIG. 1. If a record is within the given cluster, the record can be regarded as relevant to the request and further computations are performed to assign the second relevance score for the record. Conversely, if the record is not within the given cluster, the record can be regarded as not so relevant to the request and will be assigned a second relevance score of 0 instead.

In such embodiments, computing, for each respective attribute of the one or more attributes of the set of records except the one given attribute, the similarity score between the attribute value of the record and the attribute value of the request comprises identifying, for the respective attribute, one or more sub-attributes, computing, for each sub-attribute of the one or more sub-attributes, a sub-similarity score between the sub-attribute value of the record and the sub-attribute value of the request, and combining the sub-similarity scores. For example, the sub-attributes can include address line and zip code for entity address, as discussed with respect to FIG. 1.

In such embodiments, the similarity scores are computed based on Levenshtein distance.

In such embodiments, the clustering algorithm comprises k-means algorithm, k-medoid algorithm, hierarchical clustering algorithm or density-based spatial clustering of applications with noise (DBSCAN).

At 350, a given record of the set of records best matching the request is identified, based on the first relevance score for each record of the set of records and the second relevance score for each record of the set of records. For example, the given record can be matching record 130 as depicted in FIG. 1.

### Example Application Server

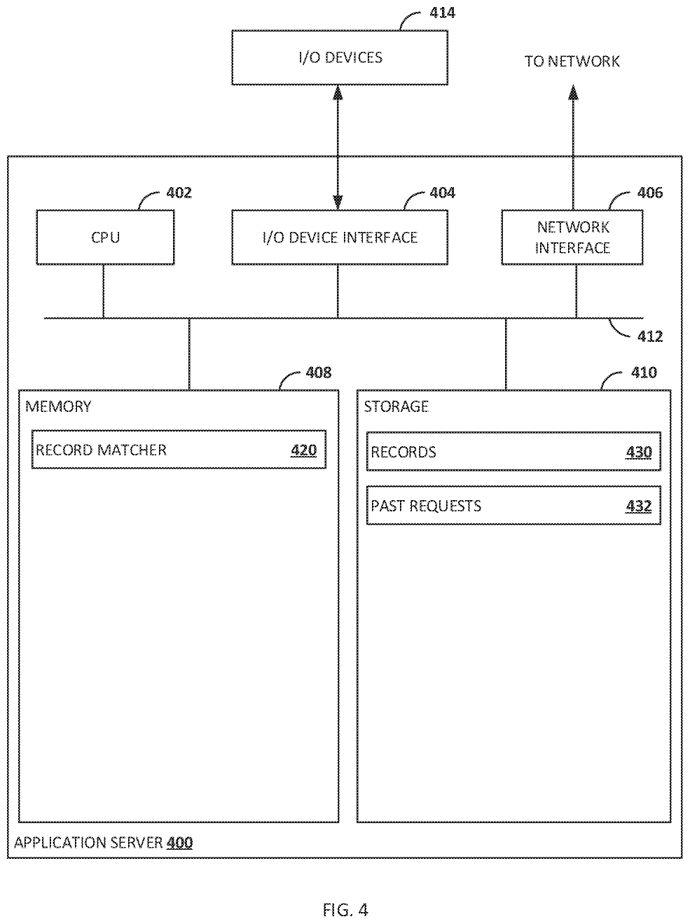

FIG. 4 depicts an example application server 400, which can be used to deploy record matcher 100 of FIG. 1. As shown, application server 400 includes a central processing unit (CPU) 402, one or more input/output (I/O) device interfaces 404, which may allow for the connection of various I/O devices 414 (e.g., keyboards, displays, mouse devices, pen input, etc.) to application server 400, a network interface 406, a memory 408, a storage 410, and an interconnect 412.

CPU 402 may retrieve and execute programming instructions stored in memory 408. Similarly, CPU 402 may retrieve and store application data residing in memory 408. Interconnect 412 transmits programming instructions and application data, among CPU 402, I/O device interface 404, network interface 406, memory 408, and storage 410. CPU 402 is included to be representative of a single CPU, multiple CPUs, a single CPU having multiple processing cores, and the like. I/O device interface 404 may provide an interface for capturing data from one or more input devices integrated into or connected to application server 400, such as keyboards, mice, touchscreens, and so on. Memory 408 may represent a random access memory (RAM), while storage 410 may be a solid state drive, for example. Although shown as a single unit, storage 410 may be a combination of fixed and/or removable storage devices, such as fixed drives, removable memory cards, network attached storage (NAS), or cloud-based storage.

As shown, memory 408 includes record matcher 420. Record matcher 420 may be the same as or substantially similar to record matcher 100 of FIG. 1.

As shown, storage 410 includes records 430 or past requests 432. Records 430 may be the same as or substantially similar to records 112 of FIG. 1, whereas past requests 432 may be the same as or substantially similar to and past requests 212 of FIG. 2.

It is noted that the components depicted in application server 400 are included as examples, and other types of computing components may be used to implement techniques described herein. For example, while memory 408 and storage 410 are depicted separately, components depicted within memory 408 and storage 410 may be stored in the same storage device or different storage devices associated with one or more computing devices.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with the language of the claims.

Within a claim, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

What is claimed is:

1. A method, comprising:
receiving a request indicating one or more attributes;
identifying, from a plurality of records using a first machine learning model, a set of records, wherein each record of the set of records indicates the one or more attributes;
computing, for each record of the set of records using a second machine learning model, a first relevance score for the record;
computing, for each record of the set of records using a third machine learning model, a second relevance score for the record; and
identifying, based on the first relevance score for each record of the set of records and the second relevance score for each record of the set of records, a given record of the set of records best matching the request.

2. The method of claim 1, wherein the first machine learning model comprises a Bidirectional Encoder Representations from Transformers (BERT) name entity recognition model.

3. The method of claim 1, wherein the second machine learning model comprises a BERT encoder.

4. The method of claim 1, wherein computing, for a given record of the set of records using the second machine learning model, the first relevance score for the given record comprises:
retrieving a weighted vector for the given record, wherein the weighted vector is generated by combining an encoded vector for the given record and a set of weights for the given record, wherein the encoded vector for the given record is generated using the second machine learning model based on one or more attribute values for the one or more attributes indicated by the given record, and wherein the set of weights for the given record are generated using a ranking algorithm with respect to a past request associated with the given record;
generating, using the second machine learning model, an encoded request based on one or more attribute values for the one or more attributes indicated by the request;
searching for the encoded request in a set of weighted vectors comprising the weighted vector using a search algorithm to generate a set of search results, wherein each search result in the set of search results indicates a respective record in the set of records and a ranking for the respective record; and
assigning a score based on the ranking of the given record in the set of search results.

5. The method of claim 4, wherein the ranking algorithm comprises Term Frequency-Inverse Document Frequency (TF-IDF) or Best Match 25 (BM25).

6. The method of claim 4, wherein the search algorithm comprises Non-Metric Space Library (NMSLIB).

7. The method of claim 1, wherein the third machine learning model comprises one or more of a linear regression model, a logistic regression model, a decision tree, a random forest, a support vector machine, or a gradient-boosted tree.

8. The method of claim 1, wherein computing, for each record of the set of records using the third machine learning model, the second relevance score for the record comprises:
clustering, using a clustering algorithm, the set of records into one or more clusters based on one given attribute of the one or more attributes of the set of records;
determining that the record is in a given cluster of the one or more clusters, wherein the given cluster includes one record whose attribute value of the one given attribute matches the attribute value of the one given attribute of the request;
computing, for each respective attribute of the one or more attributes of the set of records except the one given attribute, a similarity score between the attribute value of the record and the attribute value of the request; and
assigning a score based on the similarity scores using the third machine learning model.

9. The method of claim 8, wherein computing, for each respective attribute of the one or more attributes of the set of records except the one given attribute, the similarity score between the attribute value of the record and the attribute value of the request comprises:
identifying, for the respective attribute, one or more sub-attributes;
computing, for each sub-attribute of the one or more sub-attributes, a sub-similarity score between the sub-attribute value of the record and the sub-attribute value of the request; and
combining the sub-similarity scores.

10. The method of claim 8, wherein the similarity scores are computed based on Levenshtein distance.

11. The method of claim 8, wherein the clustering algorithm comprises k-means algorithm, k-medoid algorithm, hierarchical clustering algorithm or density-based spatial clustering of applications with noise (DBSCAN).

12. A system, comprising:
a memory including computer-executable instructions; and
a processor configured to execute the computer-executable instructions and cause the system to:
receive a request indicating one or more attributes;
identify, from a plurality of records using a first machine learning model, a set of records, wherein each record of the set of records indicates the one or more attributes;
compute, for each record of the set of records using a second machine learning model, a first relevance score for the record;
compute, for each record of the set of records using a third machine learning model, a second relevance score for the record; and
identify, based on the first relevance score for each record of the set of records and the second relevance score for each record of the set of records, a given record of the set of records best matching the request.

13. The system of claim 12, wherein the first machine learning model comprises a Bidirectional Encoder Representations from Transformers (BERT) name entity recognition model.

14. The system of claim 12, wherein the second machine learning model comprises a BERT encoder.

15. The system of claim 12, wherein computing, for a given record of the set of records using the second machine learning model, the first relevance score for the given record comprises:
retrieving a weighted vector for the given record, wherein the weighted vector is generated by combining an encoded vector for the given record and a set of weights for the given record, wherein the encoded vector for the given record is generated using the second machine learning model based on one or more attribute values for the one or more attributes indicated by the given record, and wherein the set of weights for the given record are generated using a ranking algorithm with respect to a past request associated with the given record;
generating, using the second machine learning model, an encoded request based on one or more attribute values for the one or more attributes indicated by the request;
searching for the encoded request in a set of weighted vectors comprising the weighted vector using a search algorithm to generate a set of search results, wherein each search result in the set of search results indicates a respective record in the set of records and a ranking for the respective record; and
assigning a score based on the ranking of the given record in the set of search results.

16. The system of claim 15, wherein the ranking algorithm comprises Term Frequency-Inverse Document Frequency (TF-IDF) or Best Match 25 (BM25).

17. The system of claim 15, wherein the search algorithm comprises Non-Metric Space Library (NMSLIB).

18. The system of claim 12, wherein the third machine learning model comprises one or more of a linear regression model, a logistic regression model, a decision tree, a random forest, a support vector machine, or a gradient-boosted tree.

19. The system of claim 12, wherein computing, for each record of the set of records using the third machine learning model, the second relevance score for the record comprises:
clustering, using a clustering algorithm, the set of records into one or more clusters based on one given attribute of the one or more attributes of the set of records;
determining that the record is in a given cluster of the one or more clusters, wherein the given cluster includes one record whose attribute value of the one given attribute matches the attribute value of the one given attribute of the request;
computing, for each respective attribute of the one or more attributes of the set of records except the one given attribute, a similarity score between the attribute value of the record and the attribute value of the request; and
assigning a score based on the similarity scores using the third machine learning model.

20. The system of claim 19, wherein computing, for each respective attribute of the one or more attributes of the set of records except the one given attribute, the similarity score between the attribute value of the record and the attribute value of the request comprises:
identifying, for the respective attribute, one or more sub-attributes;
computing, for each sub-attribute of the one or more sub-attributes, a sub-similarity score between the sub-attribute value of the record and the sub-attribute value of the request; and
combining the sub-similarity scores.
